(19) United States
(12) Patent Application Publication
(10) Pub. No.: US 2023/0264320 A1
(43) Pub. Date: Aug. 24, 2023

(54) METHOD AND APPARATUS FOR MINIMIZING ICE BUILD UP WITHIN BLAST NOZZLE AND AT EXIT

(71) Applicant: Cold Jet, LLC, Loveland, OH (US)

(72) Inventors: Tony R. Lehnig, Loveland, OH (US); Robert Mitchell Kocol, Cincinnati, OH (US)

(21) Appl. No.: 18/112,104

(22) Filed: Feb. 21, 2023

Related U.S. Application Data
(60) Provisional application No. 63/312,259, filed on Feb. 21, 2022.

(51) Int. Cl. B24C 7/00; B24C 1/00; B24C 5/04

(52) U.S. Cl. CPC B24C 7/0069; B24C 1/003; B24C 5/04

(57) ABSTRACT

A method and apparatus keeps ice from interfering with the flow of cryogenic particles entrained in a flow exiting a blast nozzle during continuous operation of a particle blast system. A fluid stream having appropriate temperature, moisture content and flow rate flows through an annular passageway which surrounds the nozzle.

### TECHNICAL FIELD

The present invention relates to methods and apparatuses to minimize or eliminate the buildup of ice upon the inner nozzle internal surface and adjacent the nozzle exit.

### BACKGROUND

Particle blast systems utilizing various types of blast media are well known. Systems for entraining cryogenic particles, such as solid carbon dioxide particles, in a transport fluid and for directing the entrained particles toward objects/targets are well known, as are the various component parts associated therewith, such as nozzles, and are shown in U.S. Pat. Nos. 4,744,181, 4,843,770, 5,018,667, 5,050,805, 5,071,289, 5,188,151, 5,249,426, 5,288,028, 5,301,509, 5,473,903, 5,520,572, 6,024,304, 6,042,458, 6,346,035, 6,524,172, 6,695,679, 6,695,685, 6,726,549, 6,739,529, 6,824,450, 7,112,120, 7,950,984, 8,187,057, 8,277,288, 8,869,551, 9,095,956, 9,592,586, 9,931,639, 10,315,862 and 10,737,890 all of which are incorporated herein in their entirety by reference.

Additionally, U.S. patent application Ser. No. 11/853,194, filed Sep. 11, 2007, for Particle Blast System With Synchronized Feeder and Particle Generator US Pub. No. 2009/0093196; U.S. Provisional Patent Application Ser. No. 61/589,551 filed Jan. 23, 2012, for Method And Apparatus For Sizing Carbon Dioxide Particles; U.S. Provisional Patent Application Ser. No. 61/592,313 filed Jan. 30, 2012, for Method And Apparatus For Dispensing Carbon Dioxide Particles; U.S. patent application Ser. No. 13/475,454, filed May 18, 2012, for Method And Apparatus For Forming Carbon Dioxide Pellets; U.S. patent application Ser. No. 14/062,118 filed Oct. 24, 2013 for Apparatus Including At Least An Impeller Or Diverter And For Dispensing Carbon Dioxide Particles And Method Of Use US Pub. No. 2014/0110510; U.S. patent application Ser. No. 14/516,125, filed Oct. 16, 2014, for Method And Apparatus For Forming Solid Carbon Dioxide US Pub. No. 2015/0166350; U.S. patent application Ser. No. 15/297,967, filed Oct. 19, 2016, for Blast Media Comminutor US Pub. No. 2017/0106500; U.S. patent application Ser. No. 15/961,321, filed Apr. 24, 2018 for Particle Blast Apparatus; U.S. patent application Ser. No. 16/999,633, filed Aug. 21, 2020, for Particle Blast Apparatus and Method; U.S. patent application Ser. No. 17/139,292, filed Dec. 31, 2020, for Method and Apparatus for Enhanced Blast Stream, Particle Blast Apparatus and Method; and U.S. Provisional Patent Application Ser. No. 63/185,467, filed May 7, 2021, for Method and Apparatus For Forming Solid Carbon Dioxide, are all incorporated herein in their entirety by reference.

To the extent that any material incorporated by reference conflicts with the disclosure of this patent, the disclosure of this patent prevails.

Although this patent refers specifically to carbon dioxide in explaining the innovation, the innovation is not limited to carbon dioxide but rather may be applied to any suitable cryogenic material. Thus, references to carbon dioxide herein and in the claims are not to be limited to carbon dioxide unless explicitly so stated, but are to be read to include any suitable cryogenic material.

As is well known, cryogenic particle blast systems, such as carbon dioxide particle blast systems, expel a stream of cryogenic particles, such as carbon dioxide particles, entrained in a transport gas from a blast nozzle. The size of the particles used may be dependent upon the specific application for which the blast system is used. U.S. Pat. No. 5,520,572 illustrates a particle blast apparatus that entrains small particles in a transport gas flow. The entrained flow of particles flows through a delivery hose to a blast nozzle for an ultimate use, such as being directed against a workpiece or other target. The exiting flow may be subsonic, sonic or supersonic.

Continuous operation of some blast nozzles at certain flow conditions and under certain ambient conditions may result in the buildup of water ice on the exterior of the nozzle. This build up may become larger over time during continuous use of the system and can eventually interfere with or block the flow exiting from the exit of the blast nozzle. Water ice formed on the exterior of the nozzle at the exit can break off and be ingested into the exiting flow of entrained particles, potentially damaging the target or workpiece.

### SUMMARY

The present innovation reduces, minimizes and may eliminate the buildup of ice at the blast nozzle internal surface and at the exit, reducing or completely eliminating interference and blockage. In accordance with the present innovation, at least a portion of length of the blast nozzle is surrounded with a fluid stream which is warm enough to reduce or eliminate the ice build up.

In accordance with one aspect of the present innovation, the fluid stream may be annular.

In accordance with another aspect of the present innovation, the fluid stream may flow through an annular passageway defined by a structure surrounding the exterior of the blast nozzle.

In yet a further aspect of the present innovation, the exit of the annular passageway may be proximal the exit of the blast nozzle.

### BRIEF DESCRIPTION OF THE DRAWINGS

The accompanying drawings illustrate embodiments which serve to explain the principles of the present innovation.

FIG. 1 diagrammatically illustrates an embodiment of a particle blast system configured in accordance with one or more teachings of the present innovation.

FIG. 2 is an exploded view of an embodiment of a shrouded blast nozzle assembly configured in accordance with one or more teachings of the present innovation.

FIG. 3 is a cross sectional view of the shrouded blast nozzle assembly of FIG. 2 taken at a plane through the central axis.

FIG. 4 is an enlarged fragmentary view of the discharge end of the shrouded blast nozzle assembly of FIG. 2.

FIG. 5 is an end view of nozzle 20.

FIG. 6 is a cross sectional view of the shroud of the blast nozzle assembly of FIG. 2 taken at a plane through the central axis.

FIG. 7 is a cross sectional view of an alternate embodiment of a shrouded blast nozzle assembly configured in accordance with one or more teachings of the present innovation taken at a plane through the central axis.

### DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, one or more embodiments constructed according to the teachings of the present innovation are described.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference.

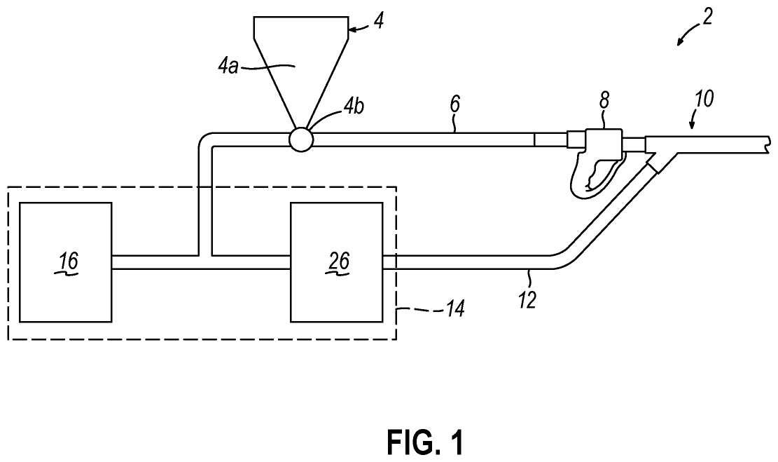

Referring to FIG. 1, there is diagrammatically shown particle blast system 2 which in the depicted embodiment is illustrated with source of cryogenic particles entrained in a flow of transport gas 4 (also referred to herein as source of entrained cryogenic particles 4), entrained flow delivery hose 6, hand control 8, discharge or blast nozzle assembly 10 and shroud fluid hose 12. Fluid source 14 is connected to shroud fluid delivery hose 12 and is configured to provide shroud fluid to discharge assembly 10. Fluid source 14 is illustrated as including pressurized fluid source 16, such as an air compressor 16, and aftercooler 26. Source of entrained cryogenic particles 4 may be connected directly to pressurized fluid source 16 as illustrated, which functions as the source of transport gas for source of entrained cryogenic particles 4, or may be connected to aftercooler 26 for its source of transport gas.

Source of entrained cryogenic particles 4 may be of any configuration which entrains cryogenic particles into a flow of transport gas. Source of entrained cryogenic particles 4 is diagrammatically illustrated as comprising hopper 4a which functions as a source of cryogenic particles for feeding portion 4b. Feeding portion 4b may be of any suitable configuration, such comprising a feeding rotor (not illustrated) which introduces particles into the flow of transport gas. In the embodiment depicted, the cryogenic particles may be carbon dioxide particles, and the innovation will be discussed hereinafter in conjunction with the use of carbon dioxide particles as the cryogenic particles, but such references are without limiting the innovation to the use of carbon dioxide particles. Thus, source of cryogenic particles entrained in a flow of entrained cryogenic particles 4 as well as is herein also referred to as source of entrained carbon dioxide particles 4, without limiting the innovation as to the specific type of cryogenic particles.

Aftercooler 26 reduces the amount of vapor in the pressurized fluid provided by compressor 16. In the embodiment depicted, the pressurized fluid is air and aftercooler 26 reduces the amount of water vapor therein. A separator may be combined with aftercooler 26. Alternately, a fluid heater could be used as part of, or to replace, aftercooler 26 to better assure the temperature of the fluid stream passing through shroud fluid hose 12 into discharge assembly 10 will prevent formation of water ice in the region outside of nozzle 20 and across internal surface 20h of nozzle 20.

Hand control 8 carries discharge assembly 10, and comprises controls which communicate with a controller (not shown) to control the operation of blast system 2. Hand control 8 may be used by an operator to orient discharge assembly 10 toward a target or workpiece such that the entrained flow exiting discharge assembly 10 impinges on the target or workpiece. Discharge assembly 10 may be carried by any suitable support besides hand control 8, such as being carried by a controllable/moveable structure, such as a robot, or may be non-moving in which case a target or workpiece may be moved relative to discharge assembly 10.

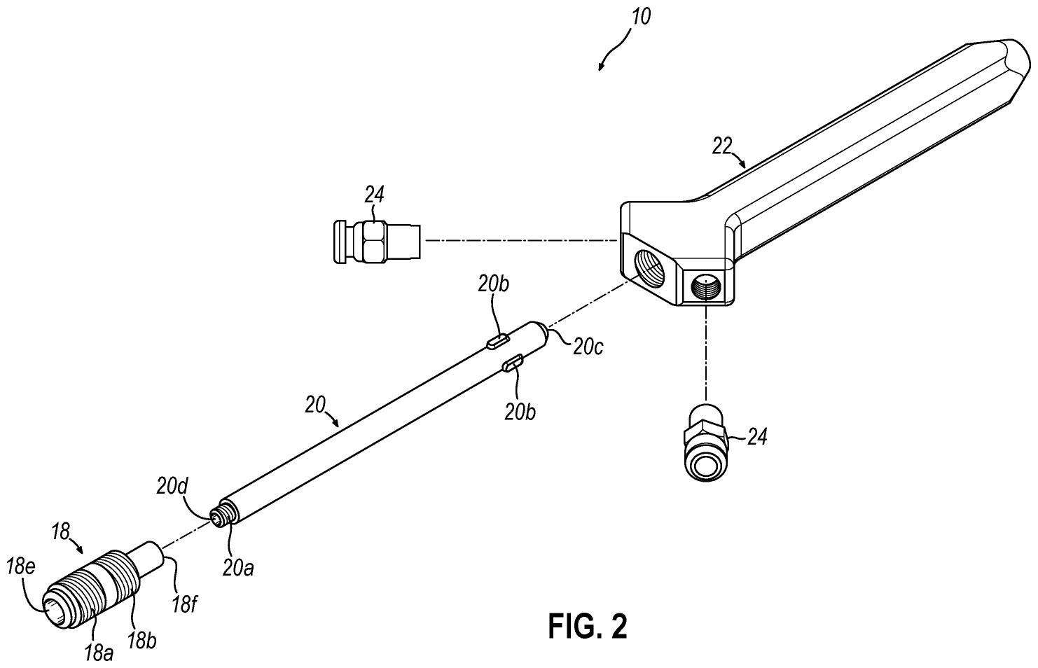

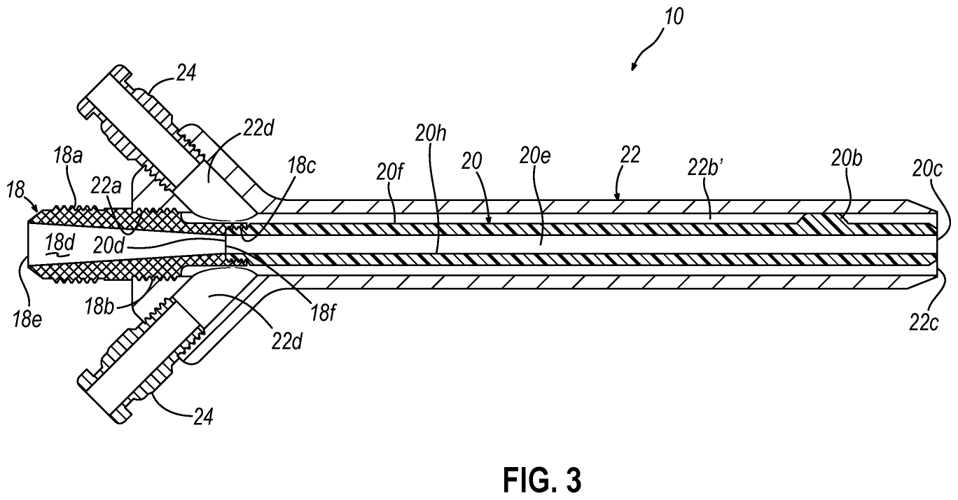

Referring to FIG. 2, there is shown an exploded view of an embodiment of discharge assembly 10, also referred to herein as blast nozzle assembly 10. In the depicted embodiment, blast nozzle assembly 10 comprises nozzle base 18, nozzle 20, shroud 22 and fittings 24. Referring also to FIG. 3, in the embodiment depicted nozzle base 18 includes first external threads 18a for connecting nozzle base 18 to hand control 8 or to any other support. Nozzle base 18 incudes second external threads 18b which are configured to threadingly engage first internal threads 22a of shroud 22 by which nozzle base 18 may be mounted to shroud 22. Nozzle base 18 includes internal threads 18c (see FIG. 3) which are configured to threadingly engage external threads 20a of nozzle 20. Threads are not the only way in which these components may be connected together. Any suitable connection configuration between nozzle base 18, nozzle 20 and shroud 22 may be used. Manufacturing techniques may allow the blast nozzle assembly to be of unitary construction, although there are advantages to the use of assemblable components such as interchangeability of a family of components allowing common parts to be assembled into different final assemblies for particular operating parameters and applications.

Nozzle base 18 and nozzle 20 of the embodiment depicted in FIG. 3 comprise a converging—diverging nozzle which when operated at the appropriate parameters, discharges supersonic entrained particle flow from exit 20c. Alternately, nozzle base 18 and nozzle 20 may be configured as a subsonic sonic nozzle or a sonic nozzle.

In the depicted embodiment, nozzle base 18 comprises internal passageway 18d which converges in the direction from inlet 18e to exit 18f (the direction of flow). In the embodiment depicted, exit 18f is formed at the upstream end of internal threads 18c, so that when connected to nozzle 20, exit 18f abuts proximal to and coinciding with inlet 20d of nozzle 20.

Nozzle 20 comprises internal passageway 20e which in the embodiment depicted diverges in the direction from inlet 20d to exit 20c. Thus, internal passageways 18d and 20e form a continuous converging—diverging passageway, with its throat (where as is well known sonic flow occurs) at exit 18f/inlet 20d.

The combined internal passageways 18d and 20e of the nozzle base 18/nozzle 20 form the nozzle passageway. Regardless of whether the nozzle passageway is configured as a subsonic, sonic or supersonic nozzle, the nozzle passageway is connectable to source of entrained carbon dioxide particles 4 to be placed in fluid communication therewith.

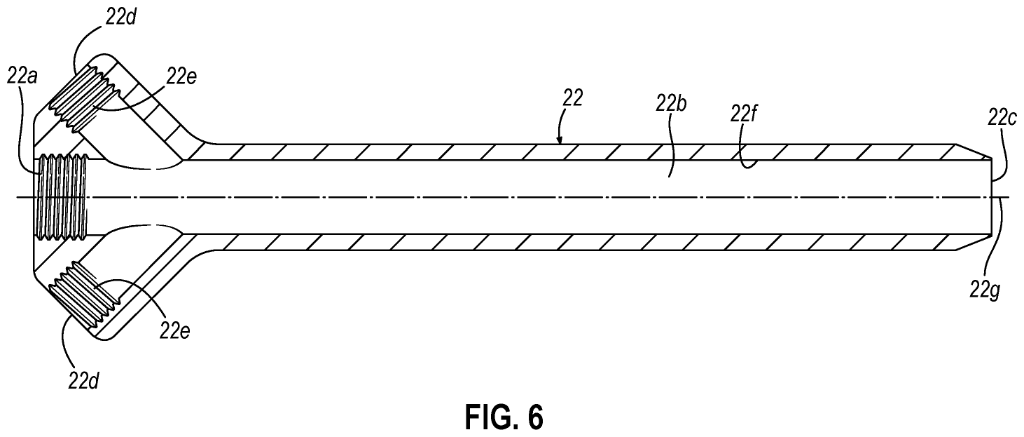

Referring also to FIG. 6, shroud 22 defines internal passageway 22b having exit 22c. Shroud 22 includes a plurality of inlets 22d at the end to which nozzle base 18 mounts which are in fluid communication with internal passageway 22b. In the embodiment depicted, there are two inlets 22d, although a single inlet or more than two inlets may be used. Each respective inlet 22d comprises respective second internal threads 22e, configured to mate with a respective fitting 24. Inlets 22d are configured to be connected to fluid source 14, which in the embodiment depicted comprises pressurized fluid source 16 and aftercooler 26 (or, alternately as mentioned previously, a fluid heater or an aftercooler and heater). In the depicted embodiment, shroud fluid hose 12 places inlets 22d and thusly internal passageway 22b in fluid communication with fluid source 18. Additionally, fluid source 14 to shroud fluid hose 12 could be provided separately from the pressurized fluid provided by compressor 16 to feeding portion 4b.

As can be seen in FIG. 3, blast nozzle assembly 10 comprises nozzle 20 coupled to nozzle base 18 as described above, with nozzle base 18 coupled to shroud 22 via second external threads 18b/first internal threads 22a thereby disposing nozzle 20 in internal passageway 20e. Nozzle 20 includes a plurality of spacers or standoffs 20b (see FIG. 5) extending radially outwardly from exterior surface 20f of nozzle 20, proximal exit 20c. As seen in FIG. 5, spacers 20b are radially spaced from one another, 120° in the embodiment depicted. Spacers 20b are longitudinally (along nozzle axis 20g) spaced from inlet 20d toward exit 20c, and are disposed to support nozzle 20 relative to interior surface 22f and to align, within tolerance, nozzle axis 20g with shroud axis 22g. Thus, the outer diameter circumscribed by spacers 20b allows nozzle 20 to be inserted into internal passageway 22b past first internal threads 22a, and rotated therein as second external threads 18b of nozzle base 18 are rotated to secure nozzle base 18 to shroud 22, while still providing the support and alignment for nozzle 20. Any suitable number and spacing of spacers 20b may be used. For example, each spacer 20b may be disposed at different axial locations, while still providing support and alignment, which may improve fluid flow through internal passageway 22b of shroud 22.

The disposition/locating of nozzle 20 within shroud 22 forms annular passageway 22b′ out of internal passageway 22b bounded for most of the length by exterior surface 20f and interior surface 22f Inlets 22d are in fluid communication with annular passageway 22b′. When inlets 22d are connected to fluid source 14, annular passageway 22b′ is in fluid communication with fluid source 14.

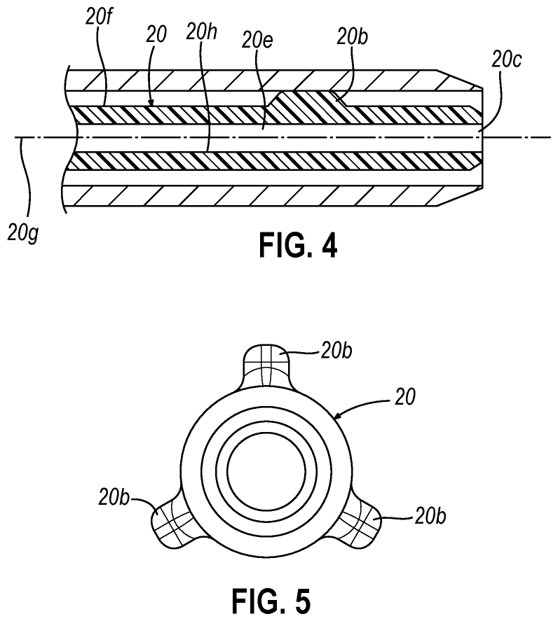

Referring also to FIG. 4, nozzle 20 and shroud 22 are arranged relative to each other such that exit 20c may be aligned with exit 22c. As discussed below, there is a functional range for the relative positions of exit 20c and exit 22c besides exact alignment.

During operation of particle blast system 2, carbon dioxide particles are introduced by feeding portion 4b into the flow of transport gas from compressor 16. The flow of entrained carbon dioxide particles travels through entrained flow delivery hose 6 to nozzle base 18. In the embodiment depicted, the flow is accelerated as it flows through the converging internal passageway 18d, reaching Mach 1 at the throat (exit 18f/inlet 20d). The flow is then further accelerated by the diverging internal passageway 20e, becoming supersonic and eventually exiting exit 20c.

Regardless of whether the flow exiting nozzle 20 is subsonic, sonic or supersonic, the temperature of the flow exiting exit 20c is very cold at cryogenic temperatures, such as as low as −200° F.

No matter what the temperature of the flow actually is, when the temperature of the exterior surface of a blast nozzle which is not shrouded in accordance with the teachings of the present innovation is below freezing, moisture in the ambient environment will form water ice on the exterior surface of the nozzle. Under certain operational parameters, ice formed on the exterior surface of the nozzle adjacent the exit will build up and eventually extend into the flow path of the exited flow of entrained particles, reducing the exit area and thus reducing the efficacy of the exiting flow. The exit may become completely occluded.

In accordance with the teachings of the present innovation, blast nozzle assembly 10 comprises nozzle 20 disposed, at least partially, in shroud 22. Nozzle 20 is surrounded with a fluid stream, for example, without limitation, air, flowing through annular passageway 22b′. The temperature, moisture content and flow rate of this fluid stream is desired to be sufficient to keep ice from interfering with the exiting flow of entrained particles during continuous operation of particle blast system 2 for an indefinite period of time. Performance may be acceptable when the temperature, moisture content and flow rate of this fluid stream is sufficient to keep ice from interfering with the exiting flow of entrained particles during continuous operation of particle blast system 2 for the entire period of its design time period for continuous operation.

Thus, in accordance with the teachings of the present innovation, ice does not build up the on the nozzle or the shroud resulting in interference with the exiting flow of entrained particles during continuous operation for at least the design time period for continuous operation. The temperature, moisture and flow rate of the fluid stream through annular passageway 22b′ is sufficient to keep ice from interfering with the flow of the fluid stream through annular passageway 22b′.

In the embodiment depicted, air is the fluid stream flowing through annular passageway 22b′. The temperature of the air at exit 22c is desirably above the dew point temperature of the ambient conditions, and the moisture content low. In the depicted embodiment, aftercooler 26 reduces the moisture content of the air flow to annular passageway 22b′. The flow rate of the fluid stream through annular passageway 22b′ should be sufficient to perform the indicated function but not such that it itself interferes with or influences the flow exiting nozzle 20.

Nozzle 20 and shroud 22 may be made of any suitable material. For example, nozzle base 18, nozzle body 20 and shroud 22 may be aluminum or titanium. Titanium offers strength even for small wall thicknesses and is resistant to damage. Titanium can also help avoid electrostatic build up when there is an appropriate path for electrostatic discharge.

The exit plane of nozzle exit 20c is illustrated in the depicted embodiment as aligned with exit 22c. There is a functional range for the relative positions of exit 20c and exit 22c besides exact alignment in conjunction with the temperature, moisture content and flow rate of the fluid stream through annular passageway 22b′. Recessing exit 20c within annular passageway 22b′ relative to exit 22c may require the fluid stream flowing through annular passageway 22b′ to have a higher temperature, lower moisture content or higher flow rate in order to keep ice from interfering with the exiting flow of entrained particles during continuous operation of particle blast system 2 for the entire period of its design time period for continuous operation. Insufficient temperature, moisture content and flow rate parameters of the fluid stream flowing through annular passageway 22b′ may allow ice build up and deleterious bridging between the shroud and nozzle.

The length of the nozzle that is surrounded by an annular passageway needs to be sufficient to keep ice from interfering with the exiting flow of entrained particles during continuous operation of particle blast system 2 for the entire period of its design time period for continuous operation, and may be dependent on the temperature, moisture content and flow rate parameters of the fluid stream flowing through the annular passageway. The portion of the nozzle that is surrounded by an annular passageway may to include the diverging portion from the throat to the exit, as illustrated in FIGS. 2-6. The shrouded portion may also include the converging portion.

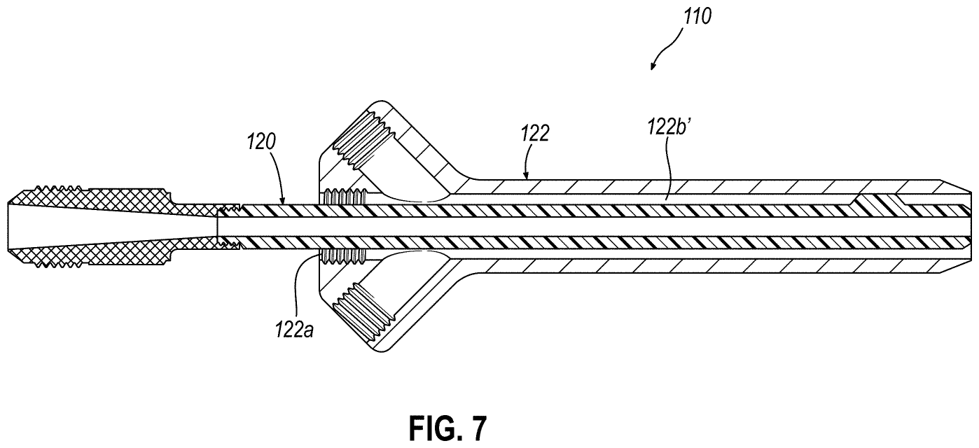

FIG. 7 illustrates an alternate embodiment of a shrouded blast nozzle assembly 110 in which annular passageway 122b′ does not surround the entire length of shroud 122. A seal 122a is formed between shroud 122 and nozzle 120. The embodiment of FIG. 7 may not provide adequate minimization of water ice building up upon the interior surface of the nozzle as all operating parameters.

### EXPLICIT DEFINITIONS

“Based on” means that something is determined at least in part by the thing that it is indicated as being “based on.” When something is completely determined by a thing, it will be described as being “based exclusively on” the thing.

“Processor” means devices which can be configured to perform the various functionality set forth in this disclosure, either individually or in combination with other devices. Examples of “processors” include microprocessors, microcontrollers, digital signal processors (DSPs), field programmable gate arrays (FPGAs), programmable logic devices (PLDs), programmable logic controllers (PLCs), state machines, gated logic, and discrete hardware circuits. The phrase “processing system” is used to refer to one or more processors, which may be included in a single device, or distributed among multiple physical devices.

A statement that a processing system is “configured” to perform one or more acts means that the processing system includes data (which may include instructions) which can be used in performing the specific acts the processing system is “configured” to do. For example, in the case of a computer (a type of “processing system”) installing Microsoft WORD on a computer “configures” that computer to function as a word processor, which it does using the instructions for Microsoft WORD in combination with other inputs, such as an operating system, and various peripherals (e.g., a keyboard, monitor, etc. . . . ).

The foregoing description of one or more embodiments of the innovation has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the innovation and its practical application to thereby enable one of ordinary skill in the art to best utilize the innovation in various embodiments and with various modifications as are suited to the particular use contemplated. Although only a limited number of embodiments of the innovation is explained in detail, it is to be understood that the innovation is not limited in its scope to the details of construction and arrangement of components set forth in the preceding description or illustrated in the drawings. The innovation is capable of other embodiments and of being practiced or carried out in various ways. Also, specific terminology was used for the sake of clarity. It is to be understood that each specific term includes all technical equivalents which operate in a similar manner to accomplish a similar purpose. It is intended that the scope of the invention be defined by the claims submitted herewith.

1. A blast nozzle assembly comprising:
a. a shroud comprising a shroud passageway, the shroud passageway comprising:
i. a shroud passageway interior surface;
ii. a shroud exit;
iii. at least one shroud inlet, each said at least one shroud inlet in fluid communication with the internal passageway and the shroud exit, each at least one shroud inlet configured to be connected to a source of shroud fluid; and
iv. a shroud direction of flow defined in the direction from the at least one shroud inlet to the shroud exit; and
b. a blast nozzle comprising an exterior surface and an internal nozzle passageway, the internal nozzle passageway configured to convey an entrained flow of cryogenic particles therethrough, the internal nozzle passageway comprising:
i. a nozzle inlet;
ii. a nozzle exit; and
iii. a nozzle direction of flow defined in the direction from the nozzle inlet to the nozzle outlet
wherein the blast nozzle is mounted to the should such that at least a portion of the exterior surface of the blast nozzle comprises an inner boundary of the shroud passageway.

2. The blast nozzle assembly of claim 1, wherein the nozzle exit is aligned with the shroud exit.

3. The blast nozzle assembly of claim 1, wherein the nozzle exit is disposed downstream of the shroud exit.

4. The blast nozzle assembly of claim 1, wherein the shroud passageway is annular.

5. The blast nozzle assembly of claim 1, wherein the blast nozzle comprises a plurality of spacers configured to support the nozzle relative to the shroud passageway interior surface.

6. The blast nozzle assembly of claim 5, wherein the nozzle comprises a nozzle axis and the shroud comprises a shroud axis, and wherein the plurality of spacers are configured to align the nozzle axis with the shroud axis.

7. The blast nozzle assembly of claim 1, wherein the internal nozzle passageway comprises a converging portion and a diverging portion disposed downstream of the converging portion.

8. A particle blast system configured for cryogenic particles, the particle blast system comprising:
a. a source of entrained cryogenic particles;
b. a source of shroud fluid
c. a blast nozzle assembly comprising
i. a shroud comprising a shroud passageway, the shroud passageway comprising:
(a) a shroud passageway interior surface;
(b) a shroud exit;
(c) at least one shroud inlet, each said at least one shroud inlet in fluid communication with the internal passageway and the shroud exit, each at least one shroud inlet in fluid communication with the source of shroud fluid; and
(d) a shroud direction of flow defined in the direction from the at least one shroud inlet to the shroud exit; and
ii. a blast nozzle comprising an exterior surface and an internal nozzle passageway, the internal nozzle passageway configured to convey an entrained flow of cryogenic particles therethrough, the internal nozzle passageway comprising:
(a) a nozzle inlet in fluid communication with the source of entrained cryogenic particles;
(b) a nozzle exit; and
(c) a nozzle direction of flow defined in the direction from the nozzle inlet to the nozzle outlet
wherein the blast nozzle is mounted to the should such that at least a portion of the exterior surface of the blast nozzle comprises an inner boundary of the shroud passageway.

9. The particle blast system of claim 8, wherein the source of shroud fluid is configured to provide shroud fluid which has a temperature above the dew point temperature of ambient conditions.

10. The particle blast system of claim 8, comprising an aftercooler configured to reduce the moisture content of the shroud fluid.

11. The particle blast system of claim 8, comprising a heater configured to increase the temperature of the shroud fluid.

12. The particle blast system of claim 8, wherein the source of shroud fluid is configured to provide shroud fluid at a temperature, moisture content and flow rate sufficient to keep ice from forming adjacent the nozzle exit and interfering with the exiting flow of entrained particles during continuous operation of the particle blast system for a period of time.

13. The particle blast system of claim 12, wherein the particle blast system has a design time period for continuous operation, and wherein the source of shroud fluid is configured to provide shroud fluid at a temperature, moisture content and flow rate sufficient to keep ice from forming adjacent the nozzle exit and interfering with the exiting flow of entrained particles during continuous operation of the particle blast system for the entirety of the design time period for continuous operation.

14. A method of reducing the buildup of ice within and at the exit of a blast nozzle through and out of which there is a flow of entrained cryogenic particles, the method comprising the steps of:
a. flowing cryogenic particles entrained in a flow of transport gas through and out of the exit of the blast nozzle for a period of time; and
b. while performing the step of flowing cryogenic particles, flowing fluid adjacent to and along a length of a portion of an exterior surface of the blast nozzle and proximal the exit of the blast nozzle, the fluid having a temperature, moisture content and flow rate sufficient to prevent interference with the flowing of cryogenic particles through and out the exit of the blast nozzle during the period of time.

15. The method of claim 14, comprising the step of removing moisture from the fluid prior to performing the step of flowing fluid.

16. The method of claim 14, comprising the step of heating the fluid prior to performing the step of flowing fluid.

17. The method of claim 14, wherein the step of flowing fluid comprises flowing the fluid through an annular passageway defined in part by the exterior surface of the blast nozzle.

18. The method of claim 14, wherein the temperature of the fluid is above the dew point temperature of ambient conditions.

19. A method of reducing the buildup of ice within and at the exit of a blast nozzle through and out of which there is a flow of entrained cryogenic particles, the method comprising the steps of:
a. flowing cryogenic particles entrained in a flow of transport gas through and out of the exit of the blast nozzle for a period of time;
b. while performing the step of flowing cryogenic particles, flowing fluid adjacent to and along a length of a portion of an exterior surface of the blast nozzle and proximal the exit of the blast nozzle, the fluid having a temperature, moisture content and flow rate; and
c. controlling the temperature, moisture sufficient and flow rate of the fluid to prevent interference with the flowing of cryogenic particles through and out the exit of the blast nozzle during the period of time.
